(19) United States
(12) Patent Application Publication
(10) Pub. No.: US 2018/0281726 A1
(43) Pub. Date: Oct. 4, 2018

(54) SEAT BELT APPARATUS

(71) Applicant: Takata Corporation, Tokyo (JP)

(72) Inventors: Yoshiki MURAKAMI, Shiga (JP); Hiroaki ISOZAKI, Shiga (JP)

(21) Appl. No.: 15/933,932

(22) Filed: Mar. 23, 2018

(30) Foreign Application Priority Data
Mar. 30, 2017 (JP) 2017-069283

(51) Int. Cl. B60R 21/18; B60R 21/235; B60R 21/237

(52) U.S. Cl. CPC B60R 21/18; B60R 21/235; B60R 2021/23519; B60R 2021/23509; B60R 21/237

(57) ABSTRACT

A seat belt apparatus includes webbing, a tubular webbing guide through which the webbing is movably inserted in an insertion direction, an inflatable airbag disposed along an outer side of the webbing guide, and a bag cover configured to cover the airbag, wherein the bag cover includes a first cover end in the insertion direction and a second cover end on an opposite side of the first cover end in the insertion direction, and the webbing guide includes a first guide end alongside the first cover end, a second guide end alongside the second cover end, and a peripheral wall continuously extending between the first guide end and the second guide end so as to form a space between the peripheral wall and the webbing.

### CROSS-REFERENCE TO RELATED APPLICATION

The present application claims priority under 35 U.S.C. § 119 to Japanese Patent Application No. 2017-069283, filed on Mar. 30, 2017, the entire contents of which are incorporated herein by reference.

### BACKGROUND OF THE INVENTION

### 1. Field of the Invention

The disclosures herein generally relate to a seat belt apparatus.

### 2. Description of the Related Art

Conventionally, an apparatus that includes webbing, a tubular bag assembly slidable along the webbing, and a cover covering an outer surface of the bag assembly is known (see Patent Document 1, for example).

However, in the conventional technique, as the webbing makes direct contact with an inner surface of the cover, there may be a case where the webbing does not slide smoothly, resulting in reduced operability when the webbing is operated by an occupant.

In light of the above, according to the disclosures herein, a seat belt apparatus that facilitates sliding of webbing is provided.

### RELATED-ART DOCUMENTS

[Patent Document 1]
[Patent Document 1] Japanese Unexamined Patent Application Publication No. 2001-260807

### SUMMARY OF THE INVENTION

According to an aspect of at least one embodiment, a seat belt apparatus includes webbing, a tubular webbing guide through which the webbing is movably inserted in an insertion direction, an inflatable airbag disposed along an outer side of the webbing guide, and a bag cover configured to cover the airbag, wherein the bag cover includes a first cover end in the insertion direction and a second cover end on an opposite side of the first cover end in the insertion direction, and the webbing guide includes a first guide end alongside the first cover end, a second guide end alongside the second cover end, and a peripheral wall continuously extending between the first guide end and the second guide end so as to form a space between the peripheral wall and the webbing.

Other objects and further features of the present invention will be apparent from the following detailed description when read in conjunction with the accompanying drawings.

### BRIEF DESCRIPTION OF THE DRAWINGS

FIG. 1 is a drawing illustrating an example of a configuration of a seat belt apparatus;

FIG. 2 is a cross-sectional view illustrating the vicinity of a tongue and an airbag of the seat belt apparatus according to an embodiment;

FIG. 3 is a cross-sectional view illustrating an example of an upper portion of an air belt;

FIG. 4 is a perspective view of the airbag being flatly spread;

FIG. 5 is a drawing illustrating an example in which an upper portion of the airbag is folded;

FIG. 6 is a drawing illustrating an example in which the airbag is entirely folded;

FIG. 7 is a cross-sectional view taken along a line A-A of FIG. 2;

FIG. 8 is a cross-sectional view illustrating an example of a lower portion of the air belt;

FIG. 9 is a drawing illustrating an example of the air belt being bent;

FIG. 10 is a cross-sectional view taken along a long-dash short-dash line B-B of FIG. 9;

FIG. 11 is a drawing illustrating an example of a cross-section of a webbing guide and webbing;

FIG. 12 is a drawing illustrating an example of a cross-section of the webbing guide and the webbing;

FIG. 13 is a drawing illustrating an example of a cross-section of a right wall;

FIG. 14 is a drawing illustrating another example of a cross-section of the right wall;

FIG. 15 is a drawing illustrating an example of a cross-section of the webbing guide and the webbing;

FIG. 16 is a drawing illustrating an example of a cross-section of the webbing guide and the webbing;

FIG. 17 is a drawing illustrating an example of a cross-section of the webbing guide and the webbing;

FIG. 18 is a perspective view illustrating an example of the webbing guide;

FIG. 19 is a drawing illustrating an example of a cross-section of the webbing guide and the webbing;

FIG. 20 is a drawing illustrating an example of a cross-section of the webbing guide and the webbing; and

FIG. 21 is a drawing illustrating an example of a cross-section of the webbing guide and the webbing.

### DESCRIPTION OF THE PREFERRED EMBODIMENTS

In the following, embodiments of the present invention will be described with reference to the accompanying drawings.

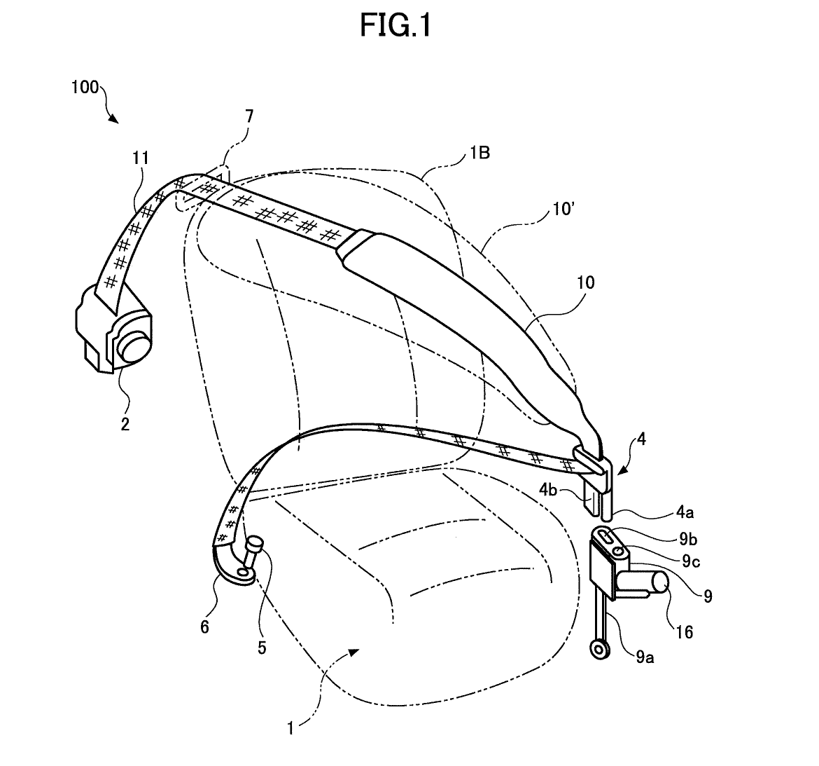

FIG. 1 is a perspective view schematically illustrating an example of a configuration of a seat belt apparatus according to an embodiment. A seat belt apparatus 100 illustrated in FIG. 1 is installed on a seat 1 of a vehicle. The seat belt apparatus 100 includes a retractor 2, webbing 11, an air belt 10, a shoulder anchor 7, a tongue 4, and a buckle 9.

The webbing 11 pulled out of the retractor 2 passes through the shoulder anchor 7 and is turned at the tongue 4. The end of the webbing 11 is fixed to an anchor plate 6. The anchor plate 6 is fixed to a fixing portion (not illustrated) of a vehicle body with a fixing bolt.

For example, the seat 1 is a front seat such as a driver's seat and a front passenger seat. The seat 1 may also be a rear seat.

In the present embodiment, the retractor 2 is provided in a B-pillar. However, depending on the position of the seat 1, the retractor 2 may be provided in or attached to, other than the B-pillar, a C-pillar or a vehicle body part such as a tray behind the rear seat. Further, the retractor 2 may be provided inside the seat 1 (inside a backrest 1B, for example).

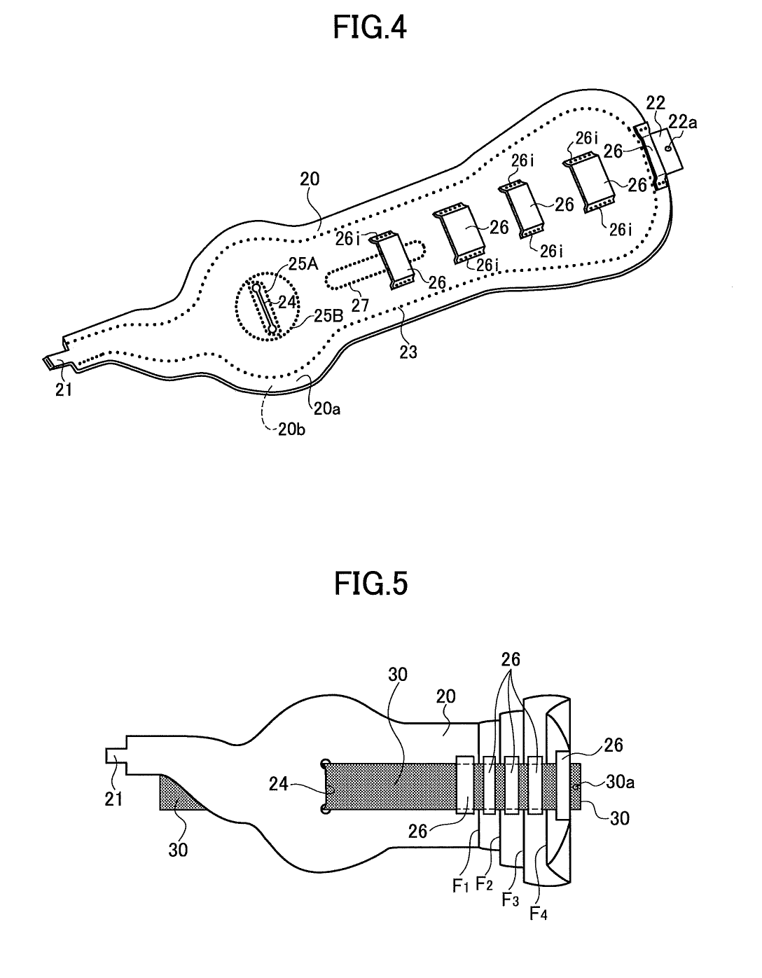

The tongue 4 is slidably attached to the webbing 11 and the air belt 10 is fitted to the webbing 11 on the shoulder anchor 7 side relative to the tongue 4. The tongue 4 includes a gas supply pipe 4a and a tongue plate 4b. The gas supply pipe 4a has a cylindrical shape and is made of metal. The gas supply pipe 4a communicates with a gas inlet port 21 at the lower end of an airbag 20, which is described later and illustrated in FIG. 4, through a gas supply path in the tongue 4 that communicates with the gas supply pipe 4a.

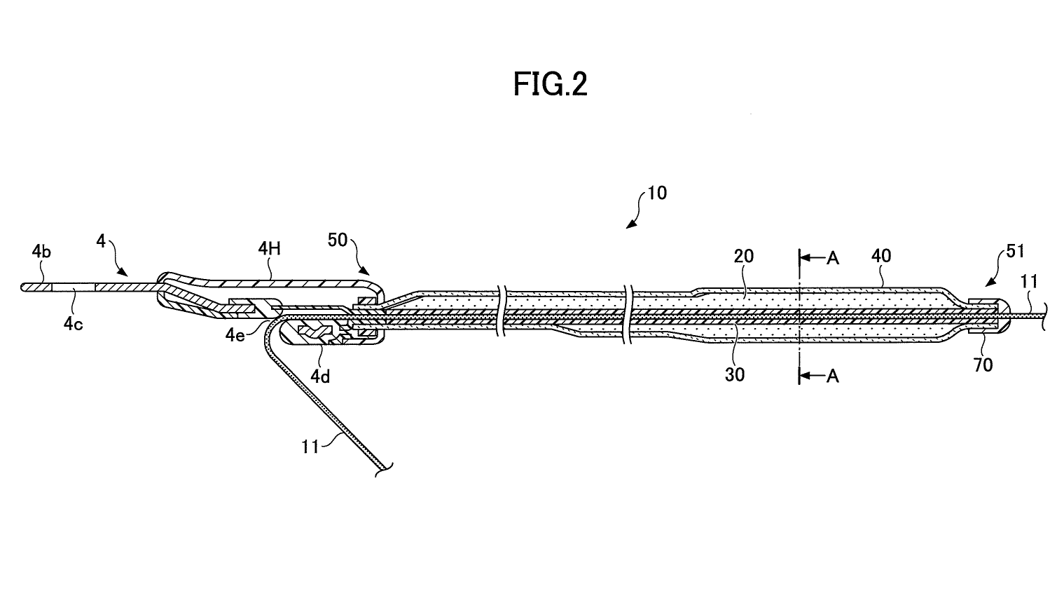

FIG. 2 is a cross-sectional view illustrating the vicinity of the tongue and the airbag of the seat belt apparatus according to the embodiment. A latch member of the buckle 9 engages with a latch hole 4c when the tongue plate 4b is inserted into the buckle 9. The latch hole 4c is provided at the front end of the tongue plate 4b of the tongue 4. The rear end of the tongue plate 4b is embedded in a resin mold 4d. The resin mold 4d is provided with an insertion port 4e through which the webbing 11 is inserted.

As illustrated in FIG. 1, the buckle 9, to and from which the tongue 4 is attached and removed, is fixed to a fixing portion (not illustrated) of the seat or the vehicle body through a bracket 9a with a fixing member such as a bolt. A tongue plate supporting hole 9b and a gas supply pipe coupling hole 9c are formed in the buckle 9. In order to attach the tongue 4, the tongue plate 4b and the gas supply pipe 4a are respectively inserted into the holes 9b and 9c of the buckle 9. An inflator 16 is provided at the buckle 9. A gas ejection port (not illustrated) of the inflator 16 communicates with the gas supply pipe coupling hole 9c into which the gas supply pipe 4a is inserted. During a collision and the like, gas is ejected from the gas ejection port of the inflator 16 by the reaction of an ignition agent in the inflator 16, causing the air belt 10 to inflate along the webbing 11 as illustrated by a long-dash double-short-dash line 10′ of FIG. 1.

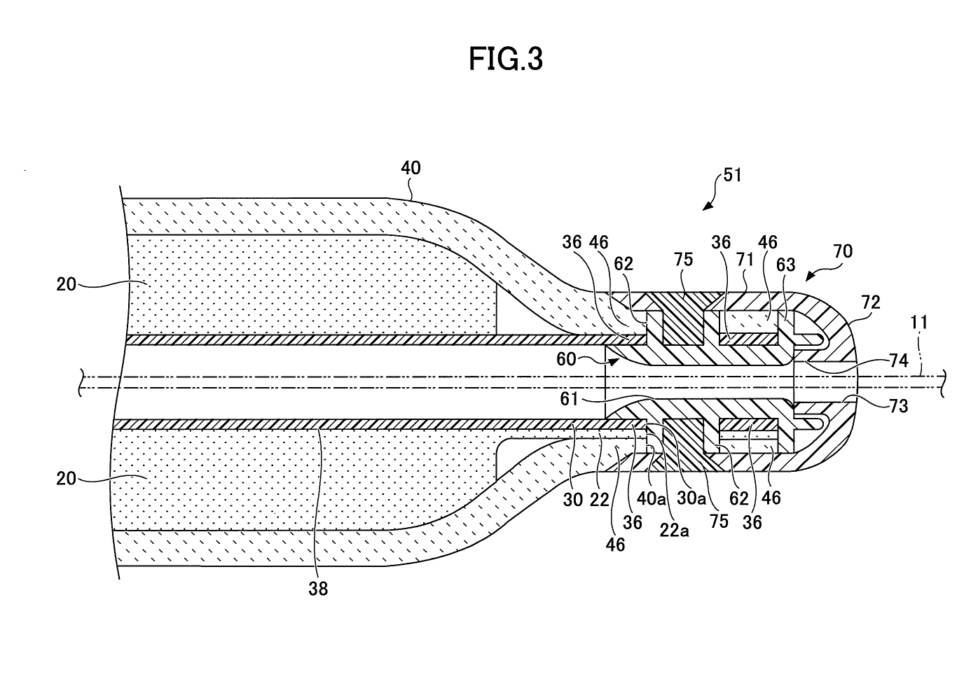

In FIG. 2, the air belt 10 includes a webbing guide 30 into which the webbing 11 is inserted, the inflatable airbag 20 extending along the webbing guide 30, and a bag cover 40 covering a folded body of the airbag 20. The airbag 20 is folded into an elongated shape in an insertion direction of the webbing guide 30 and is disposed along the outer side of the webbing guide 30. The air belt 10 also includes a lower side coupling structure portion 50 that couples the lower ends of the webbing guide 30 and the bag cover 40 to the tongue 4, and also includes an upper side coupling structure portion 51 that couples the upper ends of the airbag 20, the webbing guide 30, and the bag cover 40 to each other. FIG. 3 illustrates an inner mouth 60 and an outer mouth 70. The upper side coupling structure portion 51 will be described later in detail.

FIG. 4 is a perspective view illustrating an example of the airbag being flatly spread. The airbag 20 includes the gas inlet port 21 at its lower end (on the tongue 4 side). The airbag 20 extends in an elongated shape so as to extend along the webbing 11. A projecting portion 22 is provided at the upper end (on the shoulder anchor 7 side) of the airbag 20. The projecting portion 22 is provided with a small hole 22a.

Two elongated base fabrics 20a and 20b are overlaid and the peripheral edges of the fabrics 20a and 20b are sewed together with a sewing thread 23 such that the airbag 20 is made in an elongated bag-like shape.

A slit 24 for passing the webbing guide 30 through the airbag 20 from the base fabric 20a side to the opposite base fabric 20b side is provided on the lower end side (the tongue 4 side) of the airbag relative to the center in the longitudinal direction of the airbag 20. The base fabrics 20a and 20b are also sewed around the slit 24 with the sewing thread 25A and the sewing thread 25B.

A plurality of loops 26 for passing the webbing guide 30 are provided at spaced apart positions from near the center in the longitudinal direction of the airbag 20 to the upper end (the projecting portion 22 side) of the airbag 20. The loops 26 are made of fabric. Both sides of each of the loops 26 are sewn to the base fabric 20a of the airbag 20 with sewing threads 26i.

The base fabrics 20a and 20b are sewed together with a sewing thread 27 at a position near the center both in the longitudinal direction and in the width direction of the airbag 20. By sewing the base fabrics 20a and 20b with the sewing thread 27 and with the sewing thread 25B, the thickness of the inflated airbag 20 is restricted.

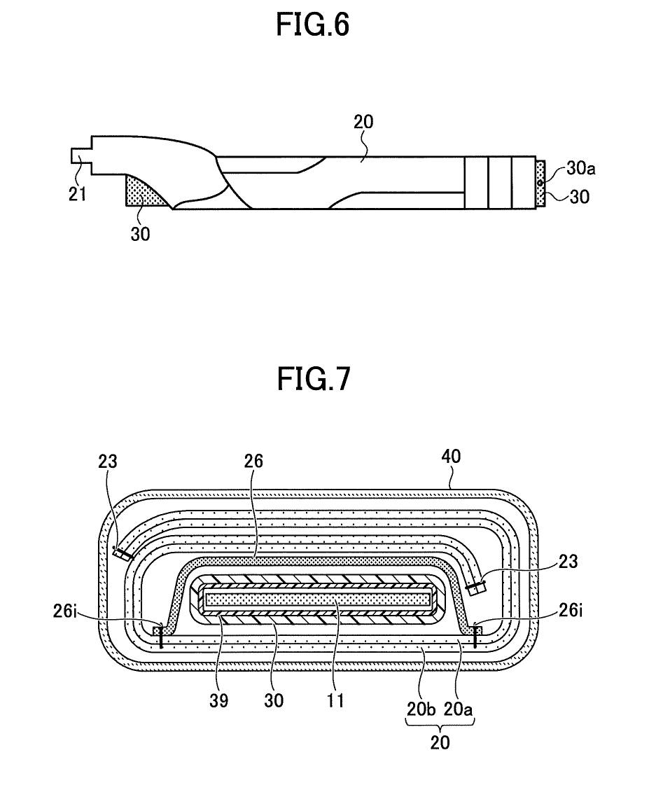

FIG. 5 is a drawing illustrating an example in which an upper portion of the airbag is folded. As illustrated in FIG. 5, the webbing guide 30 is inserted between each of the loops 26 and the base fabric 20a in a direction connecting the slit and the projecting portion 22. Although not illustrated in FIG. 5 and FIG. 6, the webbing 11 is inserted into the webbing guide 30. As illustrated in FIG. 5, the webbing guide 30 is inserted between each of the loops 26 and the base fabric 20a, passes through the slit 24 from the base fabric 20a side to the base fabric 20b side, and extends to near the gas inlet port 21. The webbing guide 30 extends continuously from the lower end to the other end of the bag cover 40.

The webbing guide 30 is a flat and elongated tubular member into which the webbing 11 is movably inserted in the insertion direction. Also, the webbing guide 30 is formed of a resin material such as polyurethane resin and silicone elastomer. The webbing guide 30 is provided with a small hole 30a (see FIGS. 3, 5, and 6) at a guide upper end 36 thereof. Other than the small hole 30a, no holes are formed on the surface in the longitudinal direction of the webbing guide 30. Therefore, even if foreign matter enters the inside of the webbing guide 30, it is possible to prevent the foreign matter from entering between the airbag 20 and the bag cover 40.

After the webbing guide is inserted through the loops 26 and the slit 24, the projecting portion 22 side of the airbag 20 is folded several times along folding lines F1 to F4 such that the airbag 20 is folded into an intermediate folded body whose entire length is reduced as illustrated in FIG. 5.

The folding lines F1 to F4 extend in a direction perpendicular to the longitudinal direction of the airbag 20. This intermediate folded body is folded along folding lines in the longitudinal direction of the airbag 20 so as to envelop the webbing guide 30, and is folded into a folded body as illustrated in FIG. 6. In the state of FIG. 6, the gas inlet port 21 and its vicinity protrude upward. Therefore, although not illustrated, this protruding portion is folded so as to overlap the webbing guide 30. Accordingly, an elongated folded body having a substantially uniform width is formed.

As illustrated in FIG. 2 and FIG. 7, the folded body of the webbing guide 30 and the airbag 20 is inserted into the bag cover 40 as illustrated in FIG. 2 and FIG. 7. The bag cover 40 is an example of a cover having a flat and elongated tubular shape. The bag cover 40 is sewn with a sewing thread that is cut by inflation pressure of the airbag 20. Alternatively, the bag cover 40 is formed of an elastic mesh that inflates as the airbag 20 inflates. In the present embodiment, the entire lengths of the webbing guide 30 and the bag cover 40 are substantially equal. Also, the positions of the lower ends and the upper ends of the webbing guide 30 and the bag cover 40 are substantially the same. The coupling structure of the upper ends (the shoulder anchor side) of the airbag 20, the webbing guide 30, and the bag cover 4 will be described with reference to FIG. 3.

FIG. 3 is a cross-sectional view illustrating an example of the upper portion of the air belt. As illustrated in FIG. 3, the airbag 20 is overlaid on the webbing guide 30, and the webbing guide 30 is surrounded by the bag cover 40. The webbing guide 30 is provided with the small hole 30a and the bag cover 40 is provided with a small hole 40a at positions overlapping the small hole 22a of the projecting portion 22 of the airbag 20.

The inner mouth 60 is inserted from the upper end of the webbing guide 30. The inner mouth 60 includes a flat annular portion 61 that is inserted into the webbing guide 30, a fitting seat 62 that protrudes from the flat annular portion 61 and has a small diameter cylindrical shape, and a flange portion 63 that is continuous with the rear end of the flat annular portion 61. The fitting seat 62 includes a first fitting seat that protrudes from a first flat portion of the flat annular portion 61 and includes a second fitting seat that protrudes from a second flat portion (located on the opposite side of the first flat portion) of the flat annular portion 61.

The outer mouth 70 made of synthetic resin is fitted on the inner mouth 60. The outer mouth 70 includes a flat annular portion 71 having a flat tubular shape, an end portion 72 provided at one end of the flat annular portion 71, a webbing insertion port 73 provided in the end portion 72, and a protruding wall 74 that protrudes from the edge of the webbing insertion port 73 toward the inside of the flat annular portion 71.

Once the inner mouth 60 and the outer mouth 70 are coupled to each other, the webbing guide 30, the projecting portion 22 of the airbag 20, and the bag cover 40 are sandwiched between the inner mouth 60 and the outer mouth 70. For example, by pushing push-in pins 75 into the first fitting seat and the second fitting seat of the fitting seat 62 after the outer mouth 70 is fitted on the inner mouth 60, the inner mouth 60 and the outer mouth 70 are coupled to each other. The structure for coupling the inner mouth 60 and the outer mouth 70 to each other is not limited to a structure that uses the push-in pins 75, and may be a structure that uses fastening members such as screws and rivets, or may be a structure that uses bonding and welding. The push-in pins 75 may be integrally formed with the outer mouth 70.

As described above, the upper ends of the airbag 20, the webbing guide 30, and the bag cover 40 are sandwiched between the inner mouth 60 and the outer mouth 70. Also, the mating faces (end faces) of the airbag 20, the webbing guide 30, and the bag cover 40 are surrounded by the inner mouth 60 and the outer mouth 70. Therefore, foreign matter is prevented from entering between the airbag 20 and the bag cover 40.

In particular, in the present embodiment, the fitting seat 62 makes contact with the small holes 22a, 30a, and 40a of the airbag 20, the webbing guide 30, and the bag cover 40. Therefore, the strength of coupling the airbag 20, the webbing guide 30, and the bag cover 40 to the inner mouth 60 and the outer mouth 70 is high.

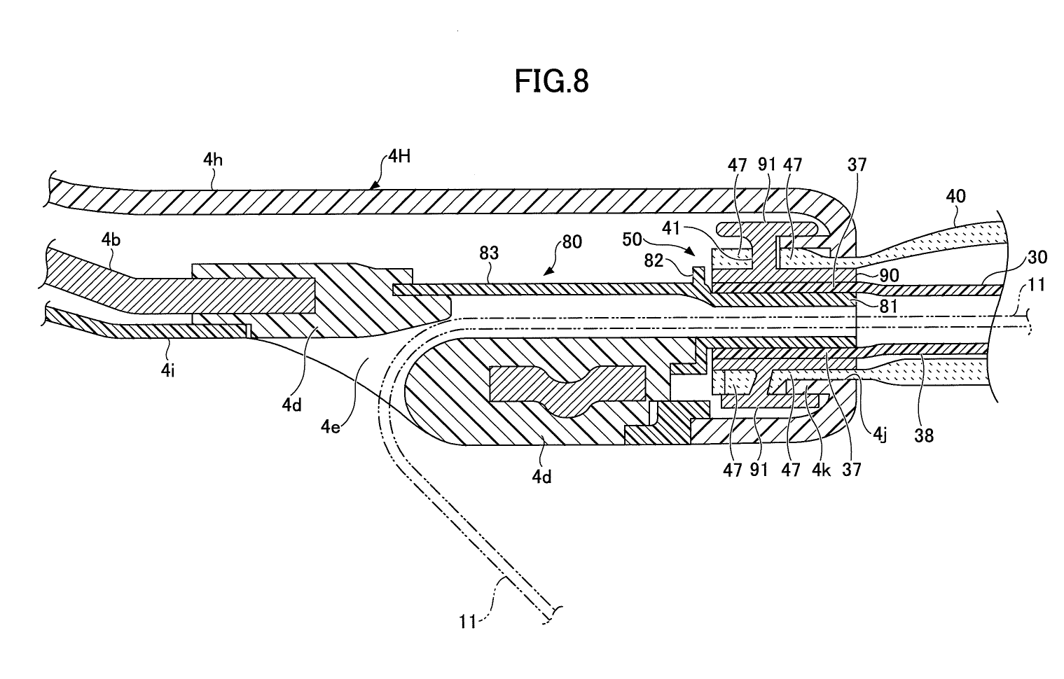

FIG. 8 is a cross-sectional view illustrating an example of the lower portion of the air belt. FIG. 8 is a cross-sectional view illustrating the lower side coupling structure portion 50 that couples the lower ends (the tongue 4 side) of the webbing guide 30 and the bag cover 40 to the tongue 4. The lower side coupling structure portion 50 includes an inner joint 80, an outer joint 90, and a housing 4H.

The housing 4H surrounds the inner joint 80, the outer joint 90, and the rear part of the tongue 4. The resin mold 4d and the tongue plate 4b are interposed by an upper housing 4h and a lower housing 4i of the housing 4H. The upper housing 4h of the housing 4H is provided with an opening 4j that receives the webbing guide 30 and the bag cover and is also provided with a protruding wall 4k that protrudes from the edge of the opening 4j.

The inner joint 80 includes a base portion 81 having a flat annular shape, a projecting portion projecting from the base portion 81 toward the front end of the tongue, and a flange portion 82 standing upward from a boundary between the base portion 81 and the projecting portion 83. The base portion 81 of the inner joint 80 is inserted into the lower end of the webbing guide 30. The inner joint 80 is inserted into the webbing guide 30 until the lower end of the webbing guide 30 comes into contact with the flange portion 82.

The lower end of the webbing guide 30 is fitted on the base portion 81 of the inner joint 80. Also, the outer joint 90 is fitted on the lower end of the webbing guide 30. The lower end of the webbing guide 30 is sandwiched between the outer joint 90 and the base portion 81 of the inner joint 80. Accordingly, the webbing guide 30 is coupled to the inner joint 80.

The outer joint 90 has a flat annular shape and is slightly larger than the base portion 81. The outer joint 90 is provided with a plurality of hooks 91 projecting from the outer surface of the outer joint 90. Small holes 41 that engage with the hooks 91 are provided near the lower end of the bag cover 40. After the small holes 41 of the bag cover engage with the hooks 91, the inner joint 80 engages with the resin mold 4d of the tongue 4.

The protruding wall 4k of the upper housing 4h engages with the hook 91. The front end of the projecting portion 83 of the inner joint 80 is in close contact with the resin mold 4d in the vicinity of the insertion port 4e of the webbing 11.

As described above, the lower end of the webbing guide 30 is sandwiched between the inner joint 80 and the outer joint 90. Also, the mating faces of the webbing guide 30 and the bag cover 4 are hermetically surrounded by the housing 4H. Accordingly, foreign matter is prevented from entering between the mating surfaces of the lower ends of the webbing guide 30 and the bag cover 40.

Further, as illustrated in FIG. 3, the bag cover 40 includes a cover upper end 46. The webbing guide 30 includes the guide upper end 36 alongside the cover upper end 46. The cover upper end 46 is an example of a first cover end in the insertion direction of the webbing 11. The guide upper end 36 is an example of a first guide end alongside the first cover end. Also, as illustrated in FIG. 8, the bag cover 40 includes a cover lower end 47. The webbing guide 30 includes a guide lower end 37 alongside the cover lower end 47. The cover lower end 47 is an example of a second cover end on the opposite side of the first cover end in the insertion direction of the webbing 11. The guide lower end 37 is an example of a second guide end alongside the second cover end.

Further, as illustrated in FIG. 3 and FIG. 8, the webbing guide 30 has a peripheral wall 38 continuously extending between the guide upper end 36 and the guide lower end 37 so as to form a space between the peripheral wall 38 and the webbing 11. Because the peripheral wall 38 continuously extends between the guide upper end 36 and the guide lower end 37, discontinuities such as holes and gaps are not formed in the peripheral wall 38. Therefore, it is possible to prevent foreign matter entering between the bag cover 40 and the webbing guide 30 via the peripheral wall 38.

Further, the space formed between the peripheral wall 38 and the webbing 11 facilitates sliding of the webbing 11.

Also, as illustrated in FIG. 7, a coating formed on the inner peripheral surface of the webbing guide 30 (the inner peripheral surface of the peripheral wall 38) further facilitate sliding of the webbing 11. For example, as main components of the coating 39, a base binder is preferably a fluorine-based resin, a lubricant is preferably a polytetrafluoroethylene (PTFE) solid lubricant, the amount of the lubricant is preferably 30% to 40%, and an additive is preferably a silicone oil.

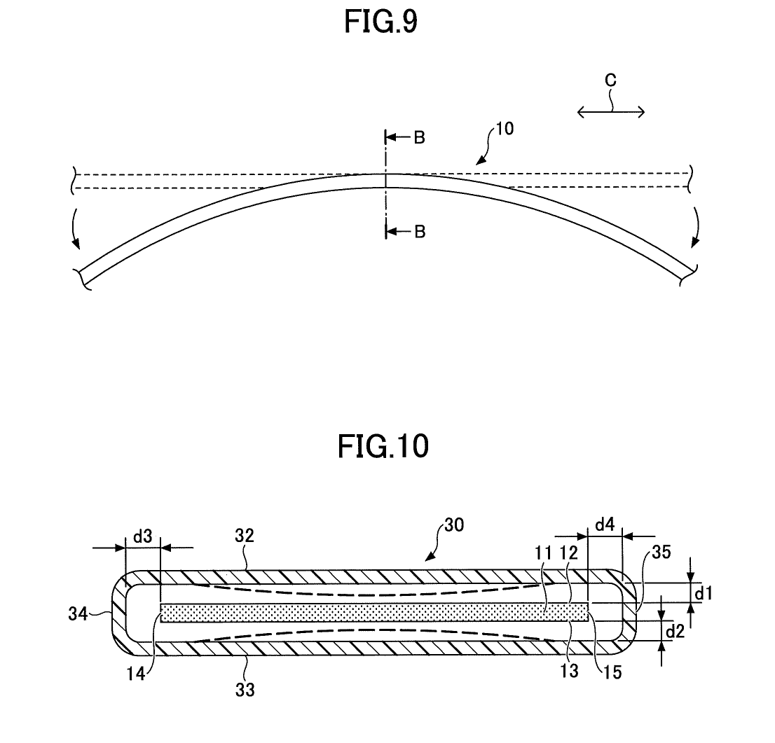

FIG. 9 is a drawing illustrating an example of the air belt being bent. Continuous lines in FIG. 9 indicate a state in which the air belt 10 is bent from a line parallel to the width direction, which is orthogonal to the longitudinal direction C of the air belt 10 (a state in which the webbing 11 and the webbing guide 30 are bent (a bent state)). Dotted lines in FIG. 9 illustrate an initial state in which no external force is applied to the air belt 10 (a state in which neither the webbing 11 nor the webbing guide 30 is bent (an unbent state)). The longitudinal direction C represents the insertion direction of the webbing 11. When an occupant wears the air belt 10, the air belt 10 is bent as illustrated in FIG. 9.

FIG. 10 is a cross-sectional view taken along a long-dash short-dash line B-B of FIG. 9. FIG. 10 illustrates deformation of the webbing guide 30 surrounding the webbing 11.

The webbing 11 has a front surface 12, a back surface 13, a left edge 14, and a right edge 15. The back surface 13 is an example of a first webbing surface on an occupant side (vehicle rear side). The front surface 12 is an example of a second webbing surface on the opposite side (vehicle front side) of the occupant side. Namely, the front surface 12 is opposite to the back surface 13.

The tubular webbing guide 30 includes the peripheral wall 38. The peripheral wall 38 includes a back wall 33 on the occupant side, a front wall 32 on the opposite side of the back wall 33, a left wall 34 connecting the front wall 32 and the back wall 33, and a right wall 35 connecting the front wall 32 and the back wall 33, on the opposite side of the left wall 34. The back wall 33 is an example of a first side wall on the occupant side. The front wall 32 is an example of a second side wall on the opposite side of the first side wall. The left wall 34 is an example of a third side wall connecting the first side wall and the second side wall. The right wall 35 is an example of a fourth side wall connecting the first side wall and the second side wall on the opposite side of the third side wall. The inner surface of the front wall 32 faces the front surface 12. The inner surface of the back wall 33 faces the back surface 13. The inner surface of the left wall 34 faces the left edge 14. The inner surface of the right wall 35 faces the right edge 15.

A distance d1 represents the minimum gap distance between the inner surface of the front wall and the front surface 12. A distance d2 represents the minimum gap distance between the inner surface of the back wall 33 and the back surface 13. A distance d3 represents the minimum gap distance between the inner surface of the left wall and the left edge 14. A distance d4 represents the minimum gap distance between the inner surface of the right wall 35 and the right edge 15.

The webbing 11 is slidably inserted into the webbing guide 30 in the longitudinal direction C.

A space formed around the webbing 11 facilitates smooth sliding (movement) of the webbing 11. As the sliding of the webbing 11 becomes smooth, the operability of pulling the webbing 11 by an occupant improves. Further, the retractor 2 can also retract the webbing 11 smoothly. However, when the webbing guide 30 is bent as illustrated in FIG. 9, a space between the webbing guide 30 and the webbing becomes small due to a difference between the inner peripheral length and the outer peripheral length of the webbing guide 30 in the longitudinal direction C. Dotted lines in FIG. 10 indicate a state in which the back wall 33 is curved and deformed toward the webbing 11 and the front wall 32 also is curved and deformed toward the webbing 11.

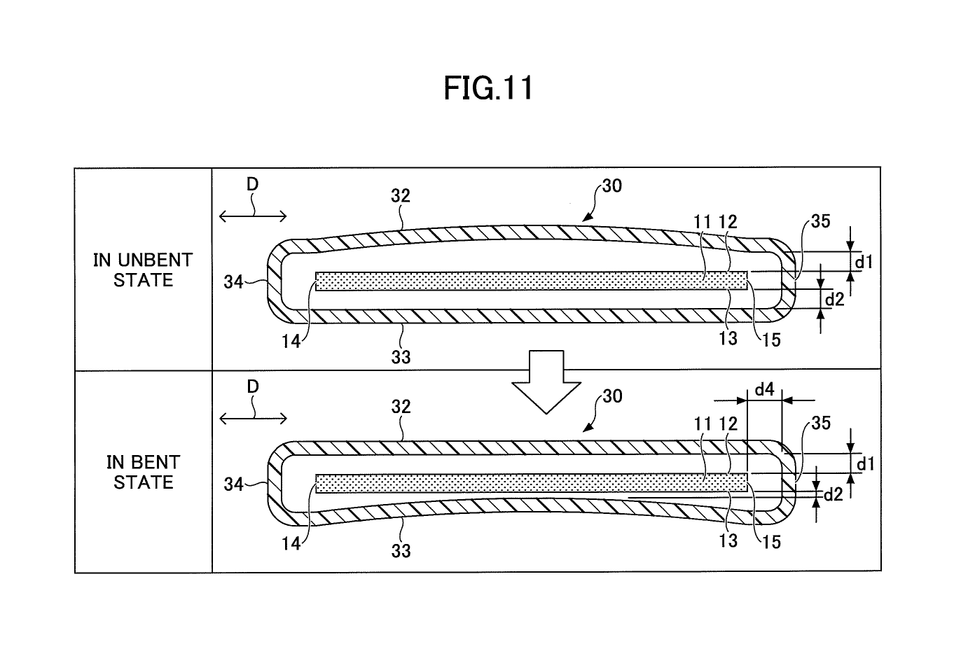

FIG. 11 is a drawing illustrating an example of a cross-section of the webbing guide and the webbing. In the unbent state, a space between the front wall 32 and the webbing 11 is made wider than a space between the back wall 33 and the webbing 11. Accordingly, in the bent state, even when the back wall 33 and the front wall 32 are deformed toward the webbing 11, it is possible to secure a sufficient space for the webbing 11 to slide. In the unbent state illustrated in FIG. 11, the front wall 32 is formed to be curved in a direction away from the webbing 11.

In the unbent state, the curvature of the front wall 32 is larger than the curvature of the back wall 33. Accordingly, in the bent state, even when the back wall 33 and the front wall 32 are deformed toward the webbing 11, it is possible to secure a sufficient space for the webbing 11 to slide. Further, in the unbent state illustrated in FIG. 11, the curvature of the back wall 33 is zero.

Further, in unbent states illustrated in figures other than FIG. 11, the curvature of the back wall 33 may also be zero. Namely, in an unbent state, the back wall 33 may be a flat wall that is not curved.

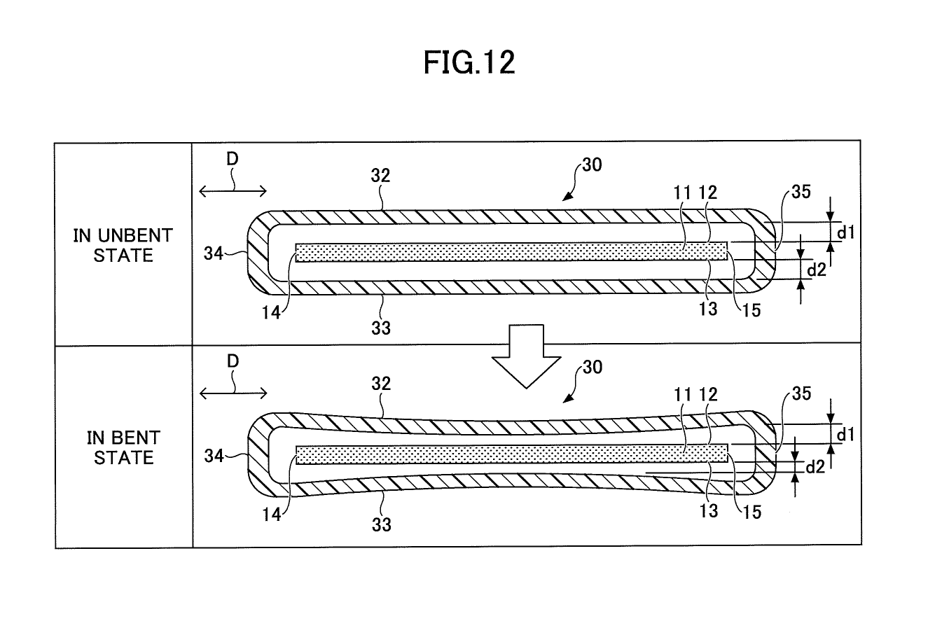

FIG. 12 is a drawing illustrating an example of a cross-section of the webbing guide and the webbing. The thickness of the left wall 34 and of the right wall 35 is made larger than the thickness of the front wall 32 and of the back wall 33. Accordingly, in the unbent state, the stiffness of the left wall 34 and of the right wall 35 becomes higher than the stiffness of the front wall 32 and of the back wall 33. In the bent state, even when the back wall 33 and the front wall 32 are deformed toward the webbing 11, it is possible to secure a sufficient space for the webbing 11 to slide.

Moreover, a structure for making the stiffness of the left wall 34 and of the right wall 35 higher than the stiffness of the front wall 32 and of the back wall 33 is not limited to the structure for varying thicknesses as illustrated in FIG. 12.

FIG. 13 is a drawing illustrating an example of a cross-section of the right wall. The right wall 35 may have a double-wall structure of an outer wall 35a and an inner wall 35b. A space 35c is formed between the outer wall 35a and the inner wall 35b. The left wall 34 also has a similar double-wall structure. These double-wall structures allow the stiffness of the left wall 34 and of the right wall 35 to become higher than the stiffness of the front wall 32 and the back wall 33. Accordingly, in the bent state, even when the back wall 33 and the front wall 32 are deformed toward the webbing 11, the left wall 34 and the right wall 35 can suppress the deformation of the front wall 32 and the back wall 33. Therefore, it is possible to secure a sufficient space for the webbing 11 to slide. Further, the right wall 35 and the left wall 34 may have a multi-wall structure of three or more walls.

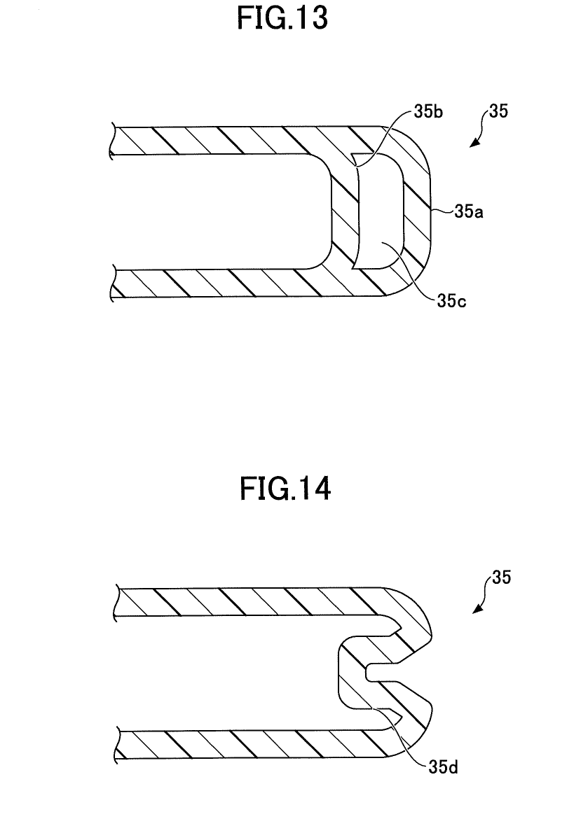

FIG. 14 is a drawing illustrating another example of a cross-section of the right wall. The right wall 35 may have a spring structure of an elastically deformed spring wall 35d. The left wall 34 also has a similar spring structure. These spring structures allow the stiffness of the left wall 34 and of the right wall 35 to become higher than the stiffness of the front wall 32 and the back wall 33. Accordingly, in the bent state, even when the back wall 33 and the front wall 32 are deformed toward the webbing 11, the left wall 34 and the right wall 35 can suppress the deformation of the front wall 32 and the back wall 33. Therefore, it is possible to secure a sufficient space for the webbing 11 to slide.

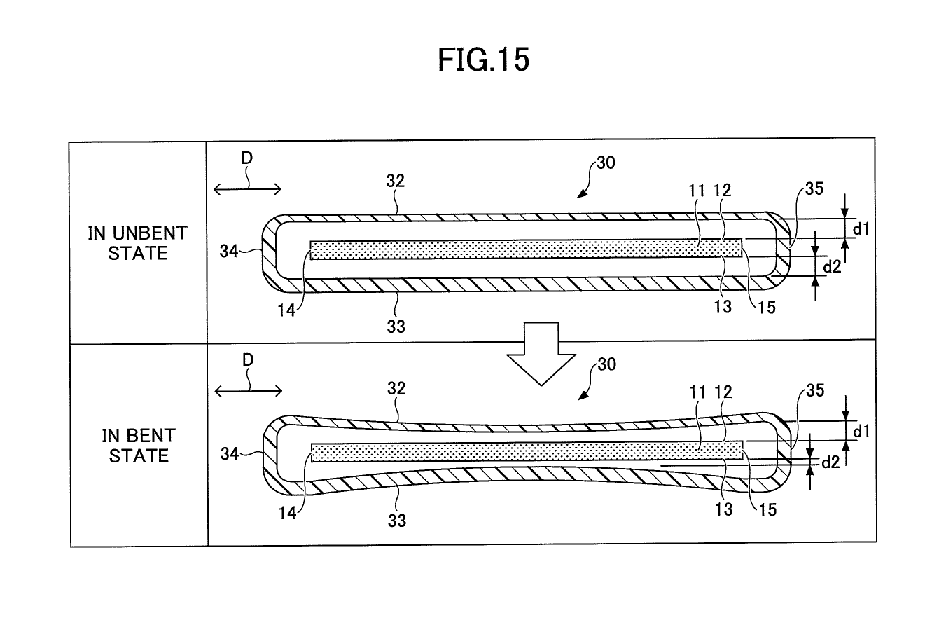

FIG. 15 is a drawing illustrating an example of a cross-section of the webbing guide and the webbing. In the unbent state, the thickness of the front wall 32 is made smaller than the thickness of the back wall 33. Thus, the stiffness of the front wall 32 becomes lower than the stiffness of the back wall 33. Accordingly, in the bent state, even when the back wall 33 and the front wall 32 are deformed toward the webbing 11, the front wall 32 easily extends in a width direction D and the longitudinal direction C, as compared to the back wall 33. As a result, the extension of the front wall 32 in the longitudinal direction C and in the width direction D can suppress the deformation of the front wall 32 toward the webbing 11. It is thus possible to secure a sufficient space for the webbing 11 to slide.

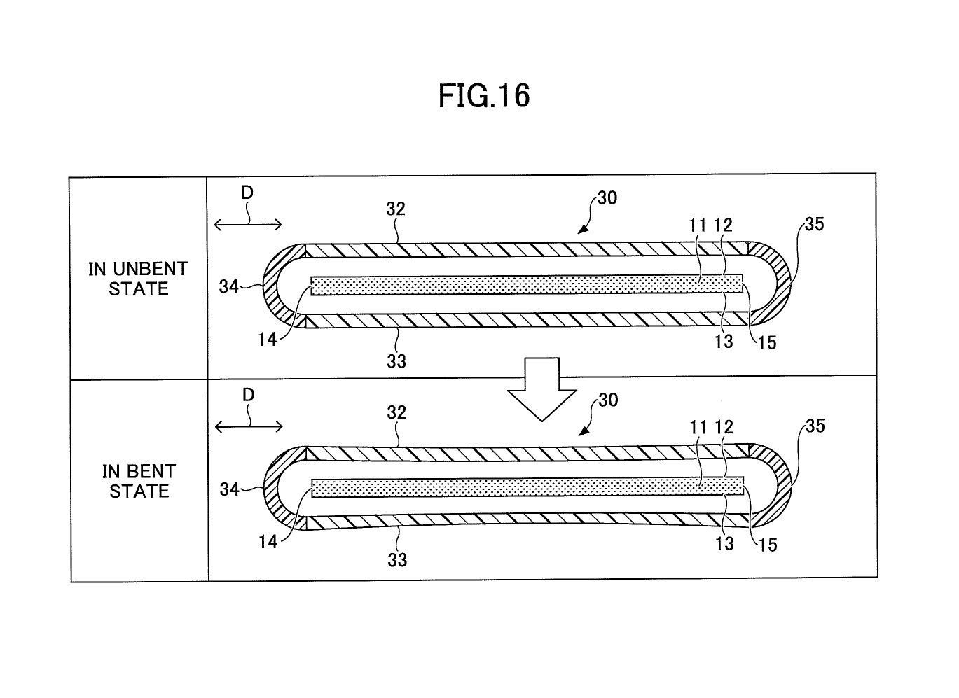

FIG. 16 is a drawing illustrating an example of a cross-section of the webbing guide and the webbing. The rigidity of the left wall 34 and of the right wall 35 is made higher than the rigidity of the front wall 32 and of the back wall 33. Thus, the stiffness of the left wall 34 and of the right wall 35 becomes higher than the stiffness of the front wall 32 and of the back wall 33. Accordingly, in the bent state, even when the back wall 33 and the front wall 32 are deformed toward the webbing 11, the left wall 34 and the right wall 35 can suppress the deformation of the front wall 32 and the back wall 33. Therefore, it is possible to secure a sufficient space for the webbing 11 to slide. For example, the front wall 32 and the back wall 33 are formed of a first flexible material having a first rigidity. The left wall 34 and the right wall 35 are formed of a second flexible material (different material from the first flexible material) having a second rigidity higher than the first rigidity. The first flexible material and the second flexible material are bonded to each other by bonding, welding, double-molding, and the like.

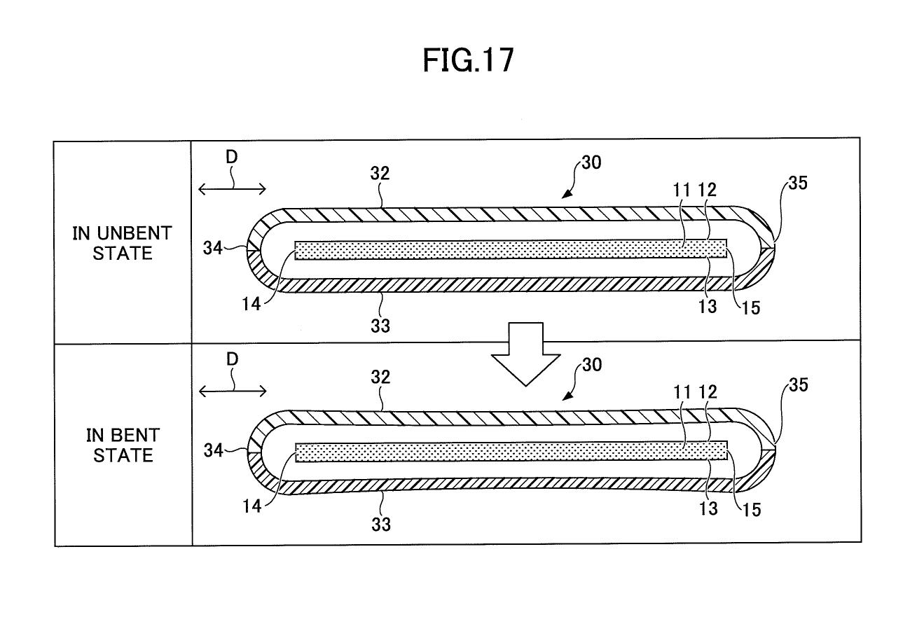

FIG. 17 is a drawing illustrating an example of a cross-section of the webbing guide and the webbing. The rigidity of the front wall 32 is made lower than the rigidity of the back wall 33. Thus, the stiffness of the front wall 32 becomes lower than the stiffness of the back wall 33. Accordingly, in the bent state, even when the back wall 33 and the front wall 32 are deformed toward the webbing 11, the front wall 32 easily extends in the longitudinal direction C and in the width direction D, as compared to the back wall 33. As a result, the extension of the front wall 32 in the longitudinal direction C and in the width direction D can suppress the deformation of the front wall 32 toward the webbing 11. It is thus possible to secure a sufficient space for the webbing 11 to slide. For example, the front wall 32 is formed of a first flexible material having the first rigidity. The back wall 33 is formed of a second flexible material (different material from the first flexible material) having the second rigidity higher than the first rigidity. The first flexible material and the second flexible material are bonded to each other by bonding, welding, and the like.

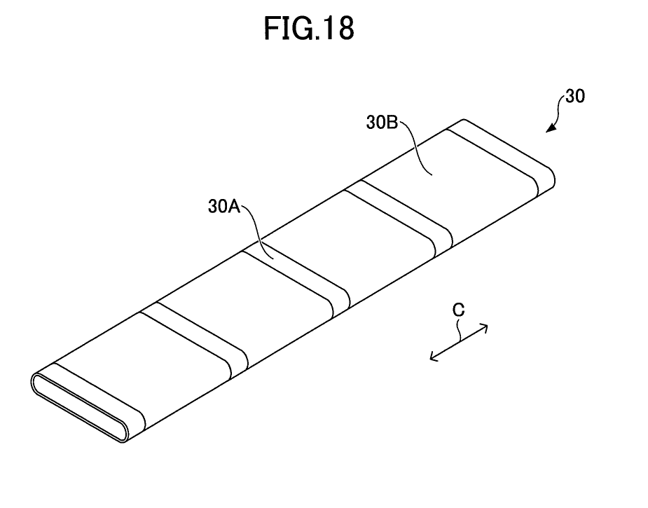

FIG. 18 is a perspective view illustrating an example of the webbing guide. The webbing guide illustrated in FIG. 18 has a configuration in which a cylindrical portion 30A formed of a flexible material and a cylindrical portion 30B having a lower rigidity than the cylindrical portion 30A are alternately bonded to each other so as to be continuous without a gap. Accordingly, in the bent state, it is possible to secure the flexibility of the webbing guide 30 while also securing a sufficient space for the webbing guide 30 to slide.

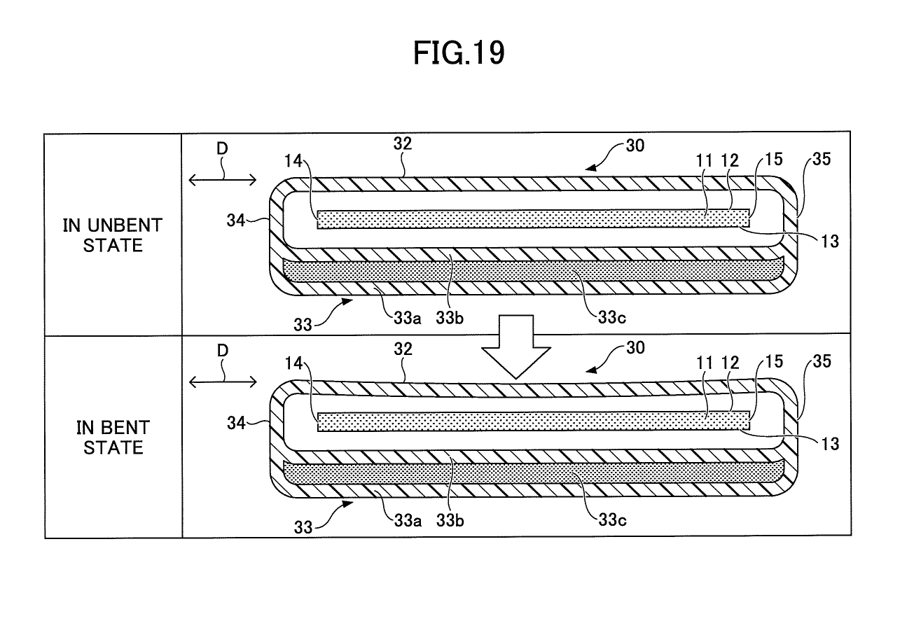

FIG. 19 is a drawing illustrating an example of a cross-section of the webbing guide and the webbing. The back wall 33 has a double-wall structure of an outer wall 33a and an inner wall 33b. A space between the outer wall 33a and the inner wall 33b is filled with a filler 33c. This structure reinforces the back wall 33, causing the stiffness of the back wall 33 to become higher than the stiffness of the front wall 32. Accordingly, in the bent state, the back wall 33 will not readily deform. It is thus possible to secure a sufficient space for the webbing 11 to slide. Further, the back wall 33 may have a multi-wall structure of three or more walls with spaces being filled with a filler. The filler may be formed by insert molding using a hard resin.

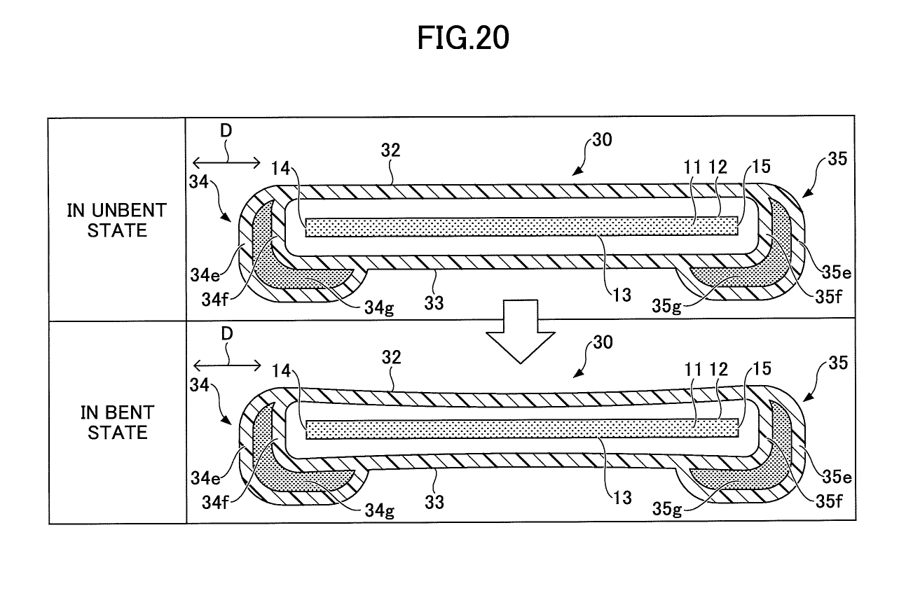

FIG. 20 is a drawing illustrating an example of a cross-section of the webbing guide and the webbing. The right wall 35 has a double-wall structure of an outer wall 35e and an inner wall 35f. A space between the outer wall 35e and the inner wall 35f is filled with a filler 35g. The left wall 34 also has a double-wall structure of an outer wall 34e and an inner wall 34f. A space between the outer wall 34e and the inner wall 34f is filled with a filler 34g. These structures allow the stiffness of the left wall 34 and of the right wall 35 to become higher than the stiffness of the front wall 32 and of the back wall 33. Accordingly, in the bent state, even when the back wall 33 and the front wall 32 are deformed toward the webbing 11, the left wall 34 and the right wall can suppress the deformation of the front wall and of the back wall 33. It is thus possible to secure a sufficient space for the webbing 11 to slide. Further, the right wall 35 and the left wall 34 may have a multi-wall structure of three or more walls with spaces being filled with a filler. Further, the filler may be formed by insert molding using a hard resin.

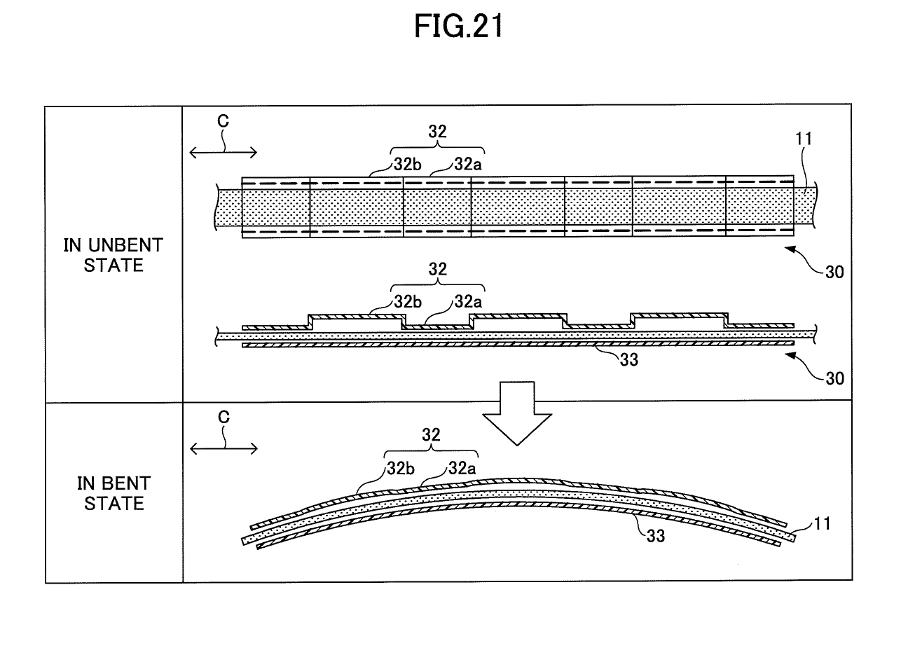

FIG. 21 is a drawing illustrating an example of a cross-section of the webbing guide and the webbing. The front wall 32 includes outer surfaces 32a and protruding surfaces 32b. The outer surfaces 32a and protruding surfaces 32b of the front wall 32 are alternately arranged without a gap. The protruding surfaces 32b protrude with respect to the outer surfaces 32a. This structure allows, in the bent state, the protruding surfaces 32b of the front wall 32 to extend in a planar manner in the longitudinal direction C, and the outer peripheral length of the front wall 32 to elongate in the longitudinal direction C. Accordingly, the difference between the outer peripheral length of the front wall 32 and the inner peripheral length of the back wall 33 becomes small. It is thus possible to secure a sufficient space for the webbing 11 to slide.

According to at least one embodiment, a peripheral wall continuously extending between a first guide end and a second guide end is provided so as to form a space between the peripheral wall and webbing, facilitating sliding of the webbing.

Although the seat belt apparatus has been described with reference to the embodiments, the present invention is not limited to the above-described embodiment. Various variations and modifications may be made without departing from the scope of the present invention.

What is claimed is

1. A seat belt apparatus comprising:
webbing;
a tubular webbing guide through which the webbing is movably inserted in an insertion direction;
an inflatable airbag disposed along an outer side of the webbing guide; and
a bag cover configured to cover the airbag,
wherein the bag cover includes a first cover end in the insertion direction and a second cover end on an opposite side of the first cover end in the insertion direction, and
the webbing guide includes a first guide end alongside the first cover end, a second guide end alongside the second cover end, and a peripheral wall continuously extending between the first guide end and the second guide end so as to form a space between the peripheral wall and the webbing.

2. The seat belt apparatus according to claim 1, wherein the peripheral wall includes a first side wall on an occupant side and a second side wall on an opposite side of the first side wall, the second side wall being formed such that, in a state in which the webbing and the webbing guide are unbent, a space between the webbing and the second side wall is wider than a space between the webbing and the first side wall.

3. The seat belt apparatus according to claim 2, wherein, in the state in which the webbing and the webbing guide are unbent, the second side wall is curved in a direction away from the webbing.

4. The seat belt apparatus according to claim 3, wherein a curvature of the second side wall is larger than a curvature of the first side wall.

5. The seat belt apparatus according to claim 1, wherein the peripheral wall includes a first side wall on an occupant side, a second side wall on an opposite side of the first side wall, a third side wall connecting the first side wall and the second side wall, and a fourth side wall connecting the first side wall and the second side wall on an opposite side of the third side wall, the third side wall and the fourth side wall having larger stiffness than the first side wall and the second side wall.

6. The seat belt apparatus according to claim 5, wherein the third side wall and the fourth side wall are thicker than the first side wall and the second side wall.

7. The seat belt apparatus according to claim 1, wherein the peripheral wall includes a first side wall on an occupant side and a second side wall on an opposite side of the first side wall, the second side wall having lower stiffness than the first side wall.

8. The seat belt apparatus according to claim 7, wherein the second side wall is thinner than the first side wall.
